(19) United States
(12) Patent Application Publication
(10) Pub. No.: US 2010/0320068 A1
(43) Pub. Date: Dec. 23, 2010

(54) PUSHBUTTON SWITCH ASSEMBLY FOR ENHANCING INPUT SENSITIVITY

(76) Inventor: Tsung-Mou Tsai, Taichung (TW)

Correspondence Address: TROP, PRUNER & HU, P.C., 1616 S. VOSS ROAD, SUITE 750, HOUSTON, TX, 77057-2631, US

(21) Appl. No.: 12/814,839

(22) Filed: Jun. 14, 2010

(30) Foreign Application Priority Data
Jun. 18, 2009 (TW) 098120471

(51) Int. Cl. H01H 13/76; H01H 1/10

(52) U.S. Cl. 200/5 A; 200/517

(57) ABSTRACT

A pushbutton switch assembly includes a key unit, a circuit board, and a press unit. The key unit includes a keycap and a press member disposed at a bottom portion of the keycap. The press member has a protruding portion. The circuit board is disposed under the key unit, and includes an electrical contact unit opposing the key unit. The electrical contact unit has a first electrode region and a second electrode region. The press unit includes a positioning film disposed on the circuit board, and a conducting plate positioned between the positioning film and the circuit board. The conducting plate is connected to the first electrode region. The conducting plate is deformed to interconnect the first and second electrode regions when the key unit is pressed and the protruding portion presses down on the positioning film, and restored when the key unit is released.

### CROSS-REFERENCE TO RELATED APPLICATION

This application claims priority of Taiwanese Application No. 098120471, filed on Jun. 18, 2009.

### BACKGROUND OF THE INVENTION

1. Field of the Invention

The present invention relates to a pushbutton switch assembly, more particularly to a pushbutton switch assembly for enhancing input sensitivity.

2. Description of the Related Art

Referring to FIG. 1, a conventional pushbutton switch assembly in an input device includes a key unit 11 and a circuit board 12 disposed under the key unit 11. The key unit 11 includes a keycap 111 and a soft conductive layer 112 formed on a bottom of the keycap 111. The circuit board 12 includes an electrical contact unit 121 opposing the conductive layer 112. The electrical contact unit 121 has a first electrode region 122 and a second electrode region 123. The first and second electrode regions 122, 123 are interconnected when the keycap 111 is pressed and the conductive layer 112 is placed in contact with the electrical contact unit 121.

The pushbutton switch assembly typically includes a plurality of the key units 11 and a plurality of the electrical contact units 121, i.e., the circuit board 12 of the pushbutton switch assembly includes said plurality of electrical contact units 121 which cooperate to form the input device.

Since the key unit 11 is made from soft material, it is not stable during pressing, such that successful switching does not always occur when the key unit 11 is pressed. Therefore, the keycap 111 may need to be pressed repeatedly and/or may need to be pressed with a significant amount of force in order to ensure that the conductive layer 112 contacts the electrical contact unit 121 in a manner to effect a switching operation.

### SUMMARY OF THE INVENTION

Therefore, the object of the present invention is to provide a pushbutton switch assembly for enhancing input sensitivity.

Accordingly, a pushbutton switch assembly of the present invention comprises a key unit, a circuit board, and a press unit. The key unit includes a keycap and a press member disposed at a bottom portion of the keycap. A hardness of the press member is greater than a hardness of the keycap. The press member has a protruding portion. The circuit board is disposed under the key unit, and includes an electrical contact unit opposing the key unit. The electrical contact unit has a first electrode region and a second electrode region. The press unit includes a positioning film disposed on the circuit board, and a conducting plate positioned between the positioning film and the circuit board. The conducting plate is connected to the first electrode region and is made from a flexible material. The conducting plate is deformed to interconnect the first and second electrode regions when the key unit is pressed and the protruding portion presses down on the positioning film, and restored when the key unit is released.

### BRIEF DESCRIPTION OF THE DRAWINGS

Other features and advantages of the present invention will become apparent in the following detailed description of the preferred embodiment with reference to the accompanying drawings, of which:

FIG. 1 is a fragmentary schematic sectional view of a conventional pushbutton switch assembly;

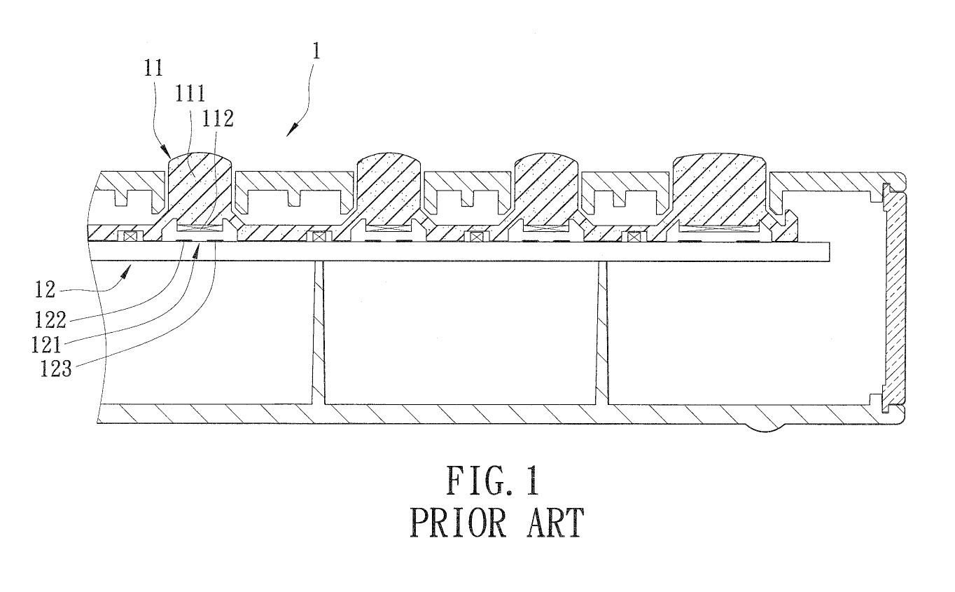

FIG. 2 is an exploded perspective view of an input device including a pushbutton switch assembly according to a preferred embodiment of the present invention;

FIG. 3 is a fragmentary schematic sectional view of the preferred embodiment of the pushbutton switch assembly;

FIG. 4 is a top view of an electrical contact unit in the preferred embodiment;

FIG. 5 is a fragmentary schematic sectional view of the preferred embodiment to illustrate key units thereof pressing down on press units, respectively; and

FIG. 6 is a fragmentary schematic sectional view of a modified example of the preferred embodiment.

### DETAILED DESCRIPTION OF THE PREFERRED EMBODIMENT

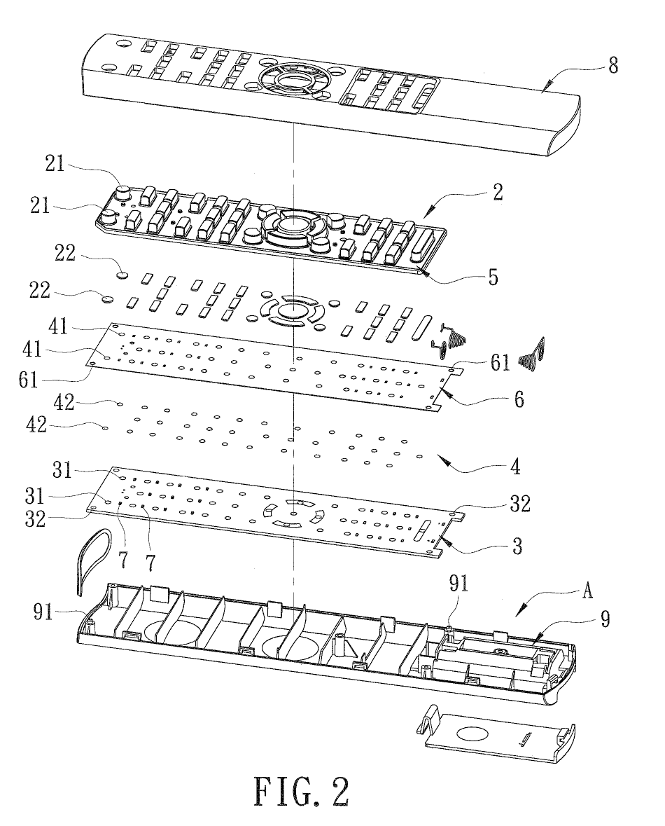

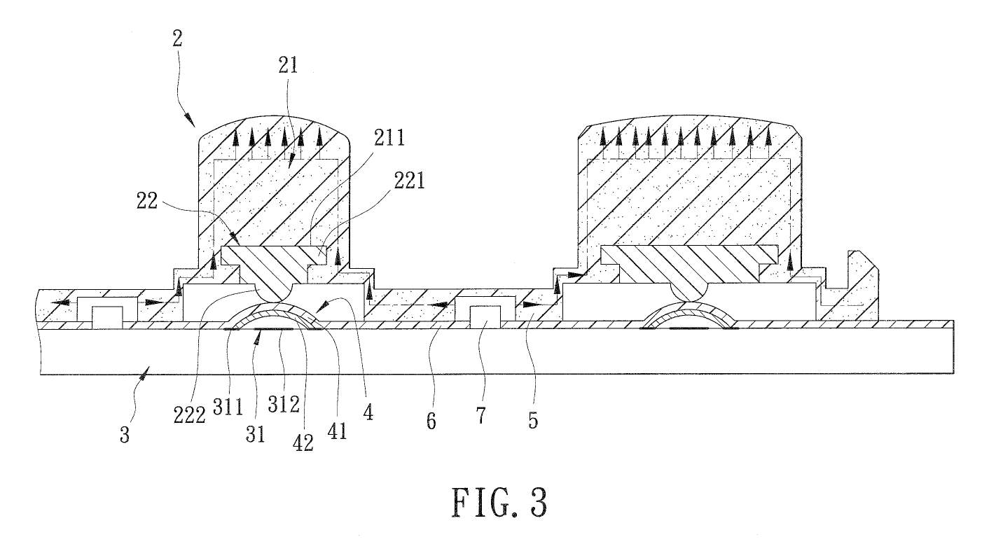

Referring to FIGS. 2 and 3, a preferred embodiment of a pushbutton switch assembly of the present invention enhances input sensitivity.

The pushbutton switch assembly comprises a key unit 2, a circuit board 3, a press unit 4, an upper case 8, and a lower case 9. In some embodiments, the pushbutton switch assembly comprises a plurality of key units 2 and a plurality of press units 4, and further comprises a keycap connection plate 5, a positioning connection plate 6, and a plurality of light emitting diodes 7, and these elements are combined together with the circuit board 3, the upper case 8, and the lower case 9 to form part of an input device, as shown in FIG. 2.

The key unit 2 includes a keycap 21 and a press member 22 disposed at a bottom portion of the keycap 21. In embodiments where there are a plurality of key units 2, each of the key units 2 includes a keycap 21 and a press member 22, and the keycap connection plate 5 bridges adjacent ones of the keycaps 21 of the key units 2. In this case, the keycap connection plate 5 and the keycaps 21 form an integral assembly.

A hardness of the press member 22 is greater than a hardness of the keycap 21. The keycap 21 is made from one of rubber and silica gel. The press member 22 is made from a plastic material, such as acrylonitrile butadiene styrene (ABS) and polycarbonate (PC). The keycap 21 has a recess portion 211. The press member 22 has an anchoring portion 221 fixedly disposed in the recess portion 211, and a protruding portion 222 extending outwardly (at least partially) from the recess portion 211.

The recess portion 211 of the keycap 21 and the anchoring portion 221 of the press member 22 are staircase-shaped. During a process of manufacturing, the press member 22 may be fabricated first, and then placed in a forming mold. The press member 22 may be covered and combined with the keycap 21 after the keycap 21 has been shaped through the injection molding process.

The circuit board 3 is disposed under the key unit 2, and includes an electrical contact unit 31 opposing the key unit 2. The electrical contact unit 31 has a first electrode region 311 and a second electrode region 312. The first and second electrode regions 311, 312 function, for example, as negative and positive electrodes, respectively. In some embodiments, the circuit board 3 includes a plurality of the electrical contact units 31 respectively opposing the key units 2. In such embodiments, each of the electrical contact units 31 includes a first electrode region 311 and a second electrode region 312.

The press unit 4 includes a positioning film 41 disposed on the circuit board 3 opposing the key unit 2, and a conducting plate 42 positioned between the positioning film 41 and the circuit board 3.

In embodiments where there are a plurality of press units 4, each of the press units 4 includes a positioning film 41 and a conducting plate 42. In such embodiments, the positioning connection plate 6 is used to bridge the positioning films 41 of the press units 4. The positioning films 41 and the positioning connection plate 6 form an integral assembly and are made from a plastic material, such as polyethylene terephthalate (PET). The positioning films 41 are used for positioning the conducting plates 42 in such a manner that the conducting plates 42 correspond in location to and are under the protruding portions 222 of the key units 2, respectively. In addition, the positioning films 41 and the positioning connection plate 6 are attached onto the circuit board 3, which protects the circuit board 3 from being oxygenized due to exposure.

The upper case 8 and the lower case 9 define an accommodating space (A). The key unit 2, the circuit board 3, and the press unit 4 are disposed in the accommodating space (A).

In some embodiments, the lower case 9 includes a pair of pillars 91, the circuit board 3 has a pair of holes 32, and the positioning connection plate 6 has a pair of positioning holes 61. The pillars 91 may be extended respectively through the holes 32 and respectively through the positioning holes 61 such that the positioning connection plate 6 can be positioned securely on the circuit board 3 and the circuit board 3 can be secured to the lower case 9.

In embodiments where there are a plurality of press units 4, the conducting plates 42 are attached to the respective positioning films 41, thereby allowing for convenient aligning of the electrical contact units 31 of the circuit board 3 during assembly. The conducting plates 42 may be made from flexible and conductive material, such as stainless steel, SUS304, copper, and so on, or may be made from flexible and non-conductive material with a conductive metal film or carbon film coating on the side that contacts the electrical contact units 31.

Each of the light emitting diodes 7 is mounted on the circuit board 3 between an adjacent pair of the key units 2 and at one of under and embedded in the keycap connection plate 5. The keycap connection plate 5 (and possibly also the key caps 23) are made of a transparent material such that light emitted from the light emitting diodes 7 is visible through the keycap connection plate (and possibly also through the keycaps 21).

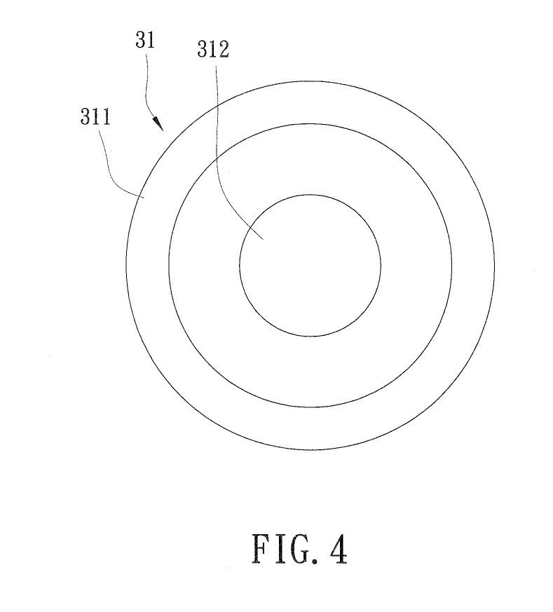

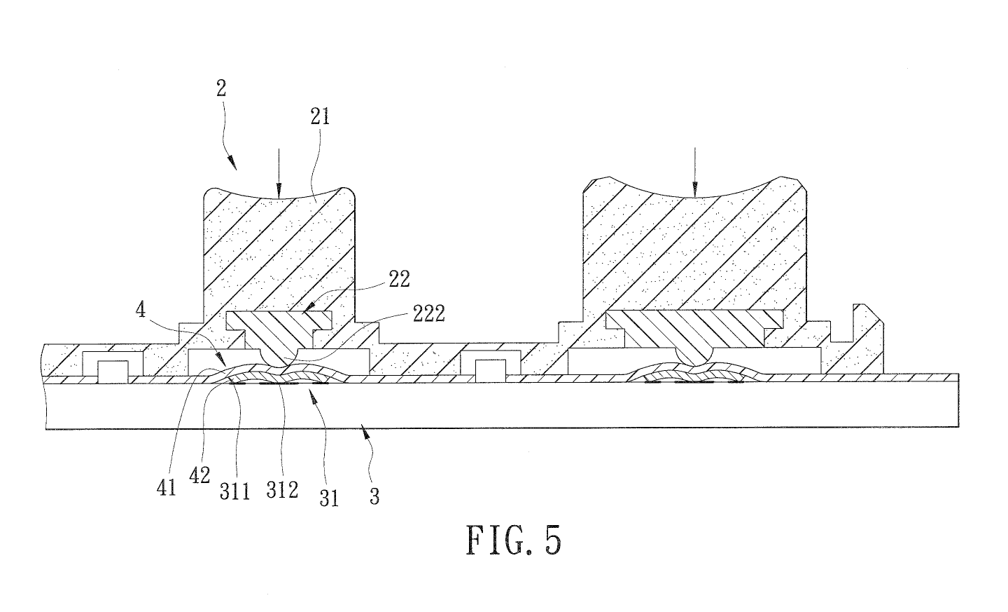

Referring to FIGS. 3, 4, and 5, in the preferred embodiment, the conducting plate 42 is dome-shaped, the first electrode region 311 of the electrical contact unit 31 is in the form of a loop, and the second electrode region 312 of the electrical contact unit 31 is in the form of a circular spot surrounded by and spaced apart from the first electrode region 311.

The conducting plate 42 is contacted to the first electrode region 311 and is made from a flexible material. The conducting plate 42 is deformed to interconnect the first and second electrode regions 311, 312 when the key unit 2 is pressed and the protruding portion 222 presses down on the positioning film 41, and restored when the key unit 2 is released. The protruding portion 222 of the key unit 2 presses down on the conducting plate 42 via the positioning film 41 such that a central portion of the conducting plate 42 is displaced and contacts the second electrode region 312 while a peripheral portion of the conducting plate 42 remains in contact with the first electrode region 311, thereby interconnecting the first and second electrode regions 311, 312 through the conducting plate 42.

In the present invention, since the press member 22 is hard, a switching operation is easily achieved by pressing down on the conducting plate 42 via the press member 22.

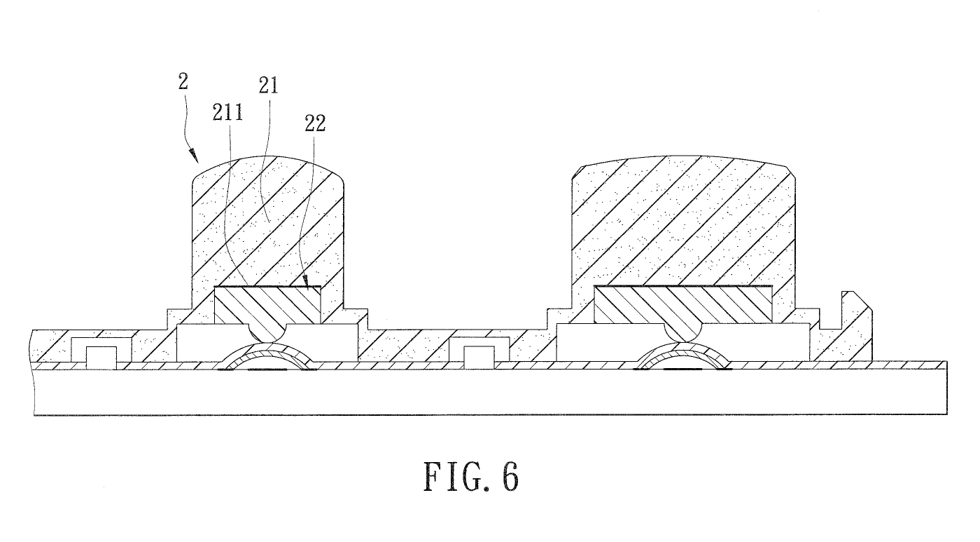

Referring to FIG. 6, in a modified example of the preferred embodiment, the keycaps 21 and the press members 22 are fabricated separately, and then interconnected using an adhesive. In such a modified example, the configurations of the recess portions 211 and the press members 22 are slightly changed to facilitate such interconnection therebetween using an adhesive.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A pushbutton switch assembly comprising:
a key unit including a keycap and a press member disposed at a bottom portion of said keycap, a hardness of said press member being greater than a hardness of said keycap, said press member having a protruding portion;
a circuit board disposed under said key unit, and that includes an electrical contact unit opposing said key unit, said electrical contact unit having a first electrode region and a second electrode region; and
a press unit including a positioning film disposed on said circuit board, and a conducting plate positioned between said positioning film and said circuit board, said conducting plate being connected to said first electrode region and being made from a flexible material, said conducting plate being deformed to interconnect said first and second electrode regions when said key unit is pressed and said protruding portion presses down on said positioning film, and restored when said key unit is released.

2. The pushbutton switch assembly as claimed in claim 1, wherein said conducting plate is dome-shaped, said first electrode region of said electrical contact unit is in the form of a loop, said second electrode region of said electrical contact unit is in the form of a circular spot surrounded by and spaced apart from said first electrode region, said protruding portion of said key unit pressing down said conducting plate via said positioning film such that a central portion of said conducting plate is displaced and contacts said second electrode region while a peripheral portion of said conducting plate remains in contact with said first electrode region, thereby interconnecting said first and second electrode regions through said conducting plate.

3. The pushbutton switch assembly as claimed in claim 2, wherein said keycap has a recess portion, and said press member has an anchoring portion fixedly disposed in said recess portion.

4. The pushbutton switch assembly as claimed in claim 3, wherein said pushbutton switch assembly comprises a plurality of said key units each including a keycap and a press member, a plurality of said electrical contact units respectively opposing said key units and each including a first electrode region and a second electrode region, and a plurality of press units each including a positioning film and a conducting plate, said pushbutton switch assembly further comprising a keycap connection plate bridging adjacent ones of said keycaps of said key units.

5. The pushbutton switch assembly as claimed in claim 4, further comprising at least one light emitting diode mounted on said circuit board between an adjacent pair of said key units and at one of under and embedded in said keycap connection plate, said keycap connection plate being made of a transparent material such light emitted from said at least one light emitting diode is visible through said keycap connection plate.

6. The pushbutton switch assembly as claimed in claim 3, further comprising a positioning connection plate to bridge said positioning films of said press units.

7. The pushbutton switch assembly as claimed in claim 6, wherein said positioning films and said positioning connection plate are made from a plastic material.

8. The pushbutton switch assembly as claimed in claim 1, wherein said keycap is made from one of rubber and silica gel.

9. The pushbutton switch assembly as claimed in claim 8, wherein said press member is made from a plastic material.

10. The pushbutton switch assembly as claimed in claim 1, further comprising an upper case and a lower case defining an accommodating space, said key unit, said circuit board, and said press unit being disposed in said accommodating space.
